(19) United States
(12) Patent Application Publication
(10) Pub. No.: US 2022/0344973 A1
(43) Pub. Date: Oct. 27, 2022

(54) CHARGING DEVICE

(71) Applicant: MAHLE International GmbH, Stuttgart (DE)

(72) Inventors: Mike Boettigheimer, Kornwestheim (DE); Daniel Deischl, Nagold (DE); Siyuan Lu, Stuttgart (DE); Timo Laemmle, Kernen (DE); Anja Sewalski, Schwieberdingen (DE)

(21) Appl. No.: 17/723,331

(22) Filed: Apr. 18, 2022

(30) Foreign Application Priority Data
Apr. 27, 2021 (DE) 10 2021 204 183.3

(51) Int. Cl. H02J 50/10; H02M 7/06; H02M 1/12; H02M 1/42; B60L 53/53; B60L 53/122

(52) U.S. Cl. CPC H02J 50/10; H02M 7/06; H02M 1/12; H02M 1/42; B60L 53/53; B60L 53/122

(57) ABSTRACT

A charging device includes a passive auxiliary circuit and a rectifier which is connected downstream of the auxiliary circuit. The passive auxiliary circuit includes input nodes and output nodes. Between the input node and the output nodes, two impedances are connected. Here, an imaginary component of the first impedance has a positive non-zero value and an imaginary component of the second impedance a negative non-zero value or vice versa.

### CROSS REFERENCE TO RELATED APPLICATIONS

This application claims priority to German patent application DE 10 2021 204 183.3, filed Apr. 27, 2021, the entire content of which is incorporated herein by reference.

### TECHNICAL FIELD

The disclosure relates to a charging device for the wireless receiving of energy.

### BACKGROUND

In an inductive charging system for electric vehicles, energy can be transmitted from a permanently installed device on the primary side to a charging device mounted in the electric vehicle on the secondary-side. For this purpose, the primary side device comprises a primary charging coil and the secondary-side charging device a secondary charging coil, which can be coupled to one another by means of a magnetic field. By way of the charging coils coupled to one another, energy is wirelessly transmitted from the primary side device to the secondary-side charging device and, if required, stored in a battery of the electric vehicle. In order to increase the energy density when transmitting energy in the charging system, the inductive charging system generally operates with a high frequency.

A major challenge with the inductive charging system is that the battery of the electric vehicle normally has a large voltage range. During the charging, the battery voltage of the battery increases continuously. For this reason, the equivalent load impedance of the battery varies greatly when the battery is charged by a constant output. Apart from this it is desirable to avoid using large capacitors and large inductors in the inductive charging system. For this reason, the inductive charging system in practice contains a large quantity of harmonic oscillations. Disadvantageously, the harmonic oscillations can result in that the actual system characteristics of the inductive charging system largely differ from the expected system characteristics.

US 10 707 693 B2 describes a charging device with an auxiliary circuit and a rectifier, which are connected between an impedance matching network and the battery of the electric vehicle. The auxiliary circuit brings about a splitting of the input current into two component currents between which there is a phase angle difference. When the battery voltage of the battery increases during the charging, the phase angle difference between the two component currents also decreases. By way of this, the variation range of the real component of an input impedance with rising battery voltage can be greatly compressed. Disadvantageously however the component currents can be unsymmetrical because of harmonic oscillations which can render the thermal design of the inductive charging system more difficult. In addition, the charging device is a very complex design and comprises a large number of components.

### SUMMARY

It is an object of the disclosure to provide a secondary-side charging device of the generic type with an improved or at least alternative embodiment, with which the described disadvantages are overcome. In particular, the variation range of a real component of an input impedance with the rising battery voltage of the battery during the wireless receiving and storing of energy is to be compressed as much as possible. In particular, the charging device is to be preferably of a simple design. In particular, the influence of harmonic oscillations in the charging device is to be reduced as much as possible.

The object is achieved by a charging device as described herein.

The charging device according to the disclosure is provided for the wireless receiving of energy. Here, the charging device comprises a passive auxiliary circuit and a rectifier which is connected downstream of the auxiliary circuit. The passive auxiliary circuit comprises a first and a second input node and a first, a second and a third output node. In particular, the passive auxiliary circuit has exactly one first input node and exactly one second input node and exactly one first output node, exactly one second output node and exactly one third output node. In particular, the passive auxiliary circuit has exactly two input nodes and exactly three output nodes. Between the first input node and the first output node a first impedance is connected. Between the first input node and the second output node a second impedance is connected. Here, an imaginary component of the first impedance has a positive non-zero value and an imaginary component of the second impedance a negative non-zero value or vice-versa.

It is to be understood that the respective imaginary paths of the respective impedance is frequency-dependent. Because of this, the imaginary component with identical components can have a positive or negative non-zero value depending on the frequency. The value of the imaginary component of the respective impedance defined here relates to a given fixed operating frequency of the charging device. Advantageously, the given fixed operating frequency can be for example 85 kHz.

By way of the charging device according to the disclosure, the variation range of a real component of an input impedance with the increasing battery voltage of a battery of an electric vehicle can be effectively compressed. Advantageously, the component selection in the charging device according to the disclosure is optimized in terms of cost and installation space. Compared with an active rectifier, exclusively passive components are used in the charging device according to the disclosure and no control system is required.

Advantageously, the charging device can be provided for the inductive charging of motor vehicles. Advantageously, the charging device can be a secondary-side charging device. Advantageously, the charging device can be provided for an electric vehicle. Advantageously, the charging device can be electromagnetically coupled to a primary side device for the wireless receiving of energy. Advantageously, the charging device can be electromagnetically coupled to a primary charging coil of a primary side device for the wireless receiving of energy via a secondary charging coil. Advantageously, the charging device can be a part of an inductive charging system. Advantageously, the primary side device can be a part of an inductive charging system.

Advantageously it can be provided that the positive value of the imaginary component of the first impedance and the negative value of the imaginary component of the second impedance are equal in the amount. However, it is to be understood that in practice the imaginary component of the first impedance can differ of the imaginary component of the second impedance by up to 20%.

Advantageously it can be provided that between the second input node and the third output node of the auxiliary circuit a third impedance is connected. Here, an imaginary component of the third impedance can have a negative or positive non-zero value or in a resonance case a value equal to zero. In other words, an imaginary component of the third impedance can have a negative or positive non-zero value or be connected in resonance with a groundwave. As already explained above, the defined value of the imaginary component of the third impedance relates to a given fixed operating frequency of the charging device. Advantageously, the given fixed operating frequency can be for example 85 kHz.

Advantageously it can be provided that the respective impedance is formed by a coil. Alternatively, it can be provided that the respective impedance is formed by a coil and a capacitor connected in series. Advantageously, the coil, in this embodiment of the respective impedance, can have higher values and the harmonic oscillations in the charging device are better suppressed.

In an advantageous further development of the charging device, it can be provided that the charging device comprises a commutation circuit which is connected between the passive auxiliary circuit and the rectifier. Here, the commutation circuit comprises at least one commutation capacitor. The at least one commutation capacitor is connected between two of the respective output nodes of the auxiliary circuit. By way of the commutation circuit, the influence of harmonic oscillations in the charging device can be effectively reduced or offset. The commutation capacitors advantageously result in a more symmetrical loading of at least some of the branches which lead from the respective input nodes of the auxiliary circuit to the respective output nodes of the auxiliary circuit.

In an advantageous configuration of the commutation circuit, the commutation circuit can comprise a first, a second and a third commutation capacitor. The first commutation capacitor is connected between the first and the second output node of the auxiliary circuit. The second commutation capacitor is connected between the second and the third output node of the auxiliary circuit. The third commutation capacitor is connected between the first and the third output node of the auxiliary circuit. The commutation capacitors are advantageously configured so that the current commutation timing is ideal.

Advantageously it can be provided that the rectifier comprises a first, a second and a third input node and a third and a second output node. Here, the respective input node of the rectifier is in each case connected to the respective output node of the auxiliary circuit. Advantageously, the rectifier can comprise three diode half bridges. Here, the respective diode half bridge is connected in each case between one of the respective input nodes of the rectifier and two of the respective output nodes of the rectifier. Advantageously, the rectifier can comprise a compensation capacitor. Here, the output capacitor can be connected between the output nodes of the rectifier.

Advantageously it can be provided that the charging device comprises a secondary charging coil for the wireless receiving of energy and a reactive power compensation network for offsetting reactive power. Here, the secondary charging coil is connected upstream of the reactive power compensation network and the reactive power compensation network is connected upstream of the auxiliary circuit. Here, the secondary charging coil can be electromagnetically and wirelessly coupled to a primary charging coil of a primary side device.

Advantageously it can be provided that the charging device comprises a battery for storing energy received. Here, the battery is connected downstream of the rectifier. Here, the battery can be installed in an electric vehicle and designed for outputting stored energy to a drive motor of the electric vehicle.

Further important features and advantages of the disclosure are obtained from the drawings and from the associated figure description by way of the drawings.

It is to be understood that the features mentioned above and still to be explained in the following cannot only be used in the respective combination stated, but also in other combinations or by themselves without leaving the scope of the present disclosure.

Exemplary embodiments of the disclosure are shown in the drawing and are explained in more detail in the following description, wherein same reference numbers relate to same or similar or functionally same components.

### BRIEF DESCRIPTION OF THE DRAWINGS

The disclosure will now be described with reference to the drawings wherein:

FIG. 1 shows a circuit diagram of a charging device according to the disclosure;

FIG. 2 shows a comparative diagram of a real component of an input impedance in the respective charging device of distinct configuration as a function of a battery voltage of a battery;

FIG. 3 shows a comparative diagram of an imaginary component of the input impedance in the respective charging device of different configuration as a function of the battery voltage of the battery;

FIGS. 4 to 7 show diagrams with a time profile of two component currents and of two component voltages in the charging device according to the disclosure with different battery voltages;

FIGS. 8 and 9 show comparative diagrams of two component currents in the respective charging device configured differently as a function of the battery voltage of the battery;

FIG. 10 shows a diagram of a phase angle difference between two component currents in the respective charging device configured differently as a function of the battery voltage of the battery; and

FIGS. 11 and 12 show comparative diagrams with a time profile of two component currents and two component voltages in the respective charging device configured differently.

### DESCRIPTION OF EXEMPLARY EMBODIMENTS

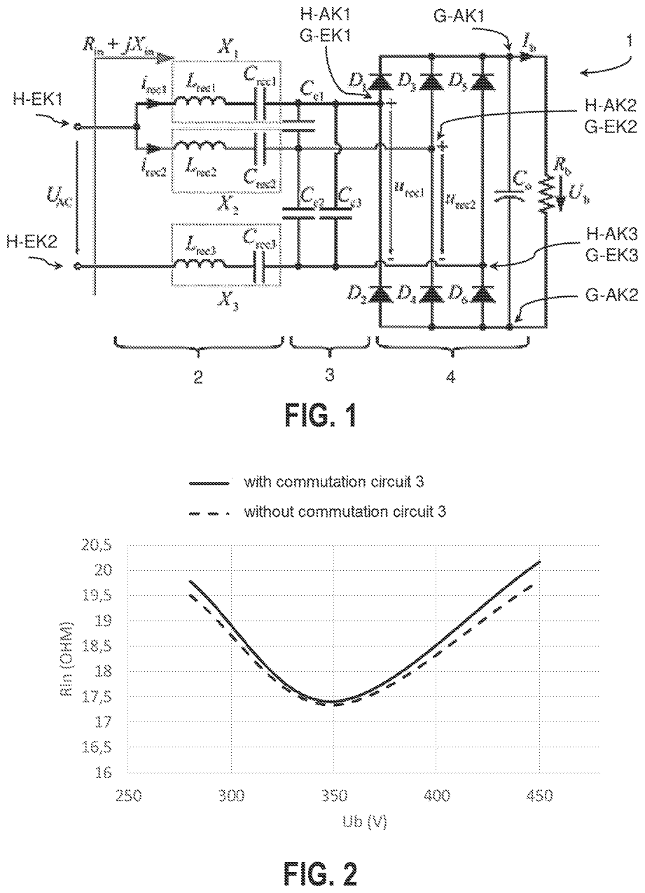

FIG.1 shows a circuit diagram of a charging device 1 according to the disclosure. Here, the charging device 1 includes an auxiliary circuit 2, a commutation circuit 3 and a rectifier 4. Here, the commutation circuit 3 is connected downstream of the auxiliary circuit 2 and upstream of the rectifier 4. In addition, the charging device 1 comprises a battery Rb which is connected downstream of the rectifier 4.

The auxiliary circuit 2 is passive. The auxiliary circuit 2 comprises exactly two input nodes—here a first and a second input node H-EK1 and H-EK2—and exactly three output nodes—here a first, a second and a third output node H-AK1, H-AK2 and H-AK3. Between the first input node H-EK1 and the first output node H-AK1 a first impedance with a coil Lrec1 and a capacitor Crec1 is connected. Here, the first impedance comprises an imaginary component X1. Between the first input node H-EK1 and the second output node H-AK2 a second impedance with a coil Lrec2 and a capacitor Crec2 is connected. Here, the second impedance comprises an imaginary component X2. Between the second input node H-EK2 and the third output node H-AK3 a third impedance with a coil Lrec3 and a capacitor Crec3 is connected. Here, the third impedance comprises an imaginary component X3.

The commutation circuit 3 is connected downstream of the auxiliary circuit 2 and comprises a first, a second and a third commutation capacitor Cc1, Cc2 and Cc3. The first commutation capacitor Ccl is connected between the first output node H-AK1 and the second output node H-AK2 of the auxiliary circuit 2. The second commutation capacitor Cc2 is connected between the second output node H-AK2 and the third output node H-AK3 of the auxiliary circuit 2. The third commutation capacitor Cc3 is connected between the first output node H-AK1 and the third output node H-AK3 of the auxiliary circuit 2.

The rectifier 4 comprises a first, a second and a third input node G-EK1, G-EK2, G-EK3. The input nodes G-EK1, G-EK2, G-EK3 coincide with the respective output nodes H-AK1, H-AK2 and H-AK3 of the auxiliary circuit 2. In addition, the rectifier 4 comprises a first and a second output node G-AK1 and G-AK2. In addition, the rectifier 4 comprises six diodes D1, D2, D3, D4, D5, D6 which are connected as diode half bridges each between the input nodes H-EK1, H-EK2, H-EK3 of the rectifier 4 and the output nodes G-AK1, G-AK2 of the rectifier 4. In addition, the rectifier 4 comprises a compensation capacitor C0, which is connected between the output nodes G-AK1 and G-AK2 of the rectifier 4. The compensation capacitor C0 is connected downstream of the diode half bridges. The battery Rb between the output nodes G-AK1 and G-AK2 of the rectifier 4 is connected downstream of the compensation capacitor C0.

Here, the charging device 1 comprises a secondary charging coil and a reactive power compensation network, both of which are not shown here. The secondary charging coil is connected upstream of the reactive power compensation network and the reactive power compensation network is connected upstream of the auxiliary circuit 2. Here, a coil alternating voltage is initiated in the secondary charging coil and an alternating voltage UAC is present at the input nodes H-EK1 and H-EK2 of the auxiliary circuit 2. Because of the reactive power compensation network connected upstream, the coil alternating voltage and the alternating voltage UAC are not identical. Here, the charging device 1 has an input impedance with a real component Rin and with an imaginary component Xin. In the auxiliary circuit 2 of the charging device 1 a first component current irec1 flows between the first input node H-EK1 and the first output node H-AK1 and a second component current irec2 flows between the first input node H-EK1 and the second output node H-AK2. A first component voltage urecl drops between the output nodes H-AK1 and H-AK3 and a second component voltage urec2 drops between the output nodes H-AK2 and H-AK3. On the battery Rb, the battery current lb flows and a battery voltage Ub drops.

In the charging device 1, the imaginary component X1 of the first impedance has a positive value and the imaginary component X2 of the second impedance a negative value or vice versa. This leads to a phase shift between the first component current irecl and the second component current irec2. Here, the mentioned phase shift varies with the battery voltage Ub. Because of this, the variation range of the real component Rin of the input impedance with the rising battery voltage Ub is greatly compressed. Apart from this, the imaginary component Xin of the input impedance can be reduced through the commutation capacitors Cc1, Cc2 and Cc3 of the commutation circuit 3. The commutation circuit 3 leads to a symmetrical loading of the branches between the input nodes H-EK1 and the output nodes H-AK1, H-AK2. The commutation circuit 3 is optional. Advantageously, the imaginary component X1 of the first impedance and the imaginary component X2 of the second impedance can be the same in the amount. The imaginary component X3 of the third impedance can advantageously have a value equal to zero. Accordingly, the coil Lrec3 and the capacitor Crec3 can be omitted.

The advantage of the charging device 1 according to the disclosure lies in the optimized component selection as a result of which costs, weight and installation space can be saved.

In FIGS. 2 to 10, characteristics of the charging device according to the disclosure are illustrated on the basis of a simulation. The values of the respective imaginary components X1, X2, X3 of the respective impedances defined in the simulation are based on a given fixed operating frequency of 85 kHz. The following exemplary values were employed for the simulation:

Lrec1=19.48 μH UAC=449.7 V

Lrec2=19.27 Mh P to 10,000 W

Lrec3=18.12 μH Ub=280V to 450V

Crec1=1817.9 nF Cc1=137 pF

Crec2=90.89 nF Cc2=263 pF

Crec3=193.48 nF Cc3=415 pF

FIG. 2 shows a comparative diagram of the real component Rin of the input impedance in the charging device 1 as a function of the battery voltage Ub of the battery Rb. The profile of the real component Rin of the input impedance in the charging device 1 according to FIG. 1 with the commutation circuit 3 is shown with a continuous line. Here, the profile of the real component Rin of the input impedance in the charging device 1 according to FIG. 1 without the commutation circuit 3 is shown with a dashed line.

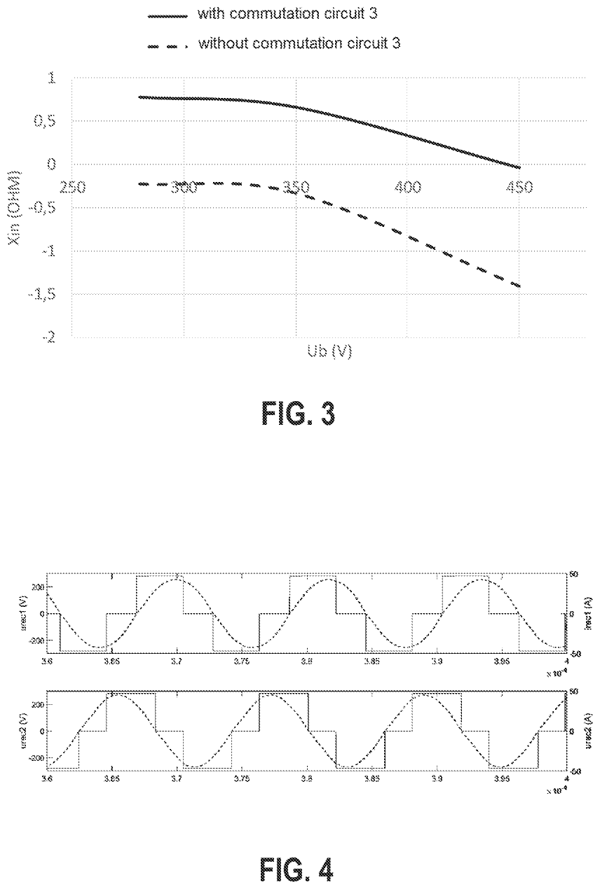

FIG. 3 shows a comparative diagram of the imaginary component Xin of the input impedance in the charging device 1 as a function of the battery voltage Ub of the battery Rb. Here, the profile of the imaginary component Xin of the input impedance in the charging device 1 according to FIG. 1 with the commutation circuit 3 is shown with a continuous line. Here, the profile of the imaginary component Xin of the input impedance in the charging device 1 according to FIG. 1 without the commutation circuit 3 is shown with a dashed line.

FIG. 4 shows a diagram with a time profile of the component currents irec1 and irec2 and of the two component voltages urecl and urec2 in the charging device 1 according to the disclosure with the battery voltage Ub of 280V without the commutation circuit 3. In the upper part diagram, the component current irec1 is plotted with the dotted line and the component voltage urec1 with the continuous line. In the lower part diagram, the component current irec2 is plotted with the dotted line and the component voltage urec2 with the continuous line.

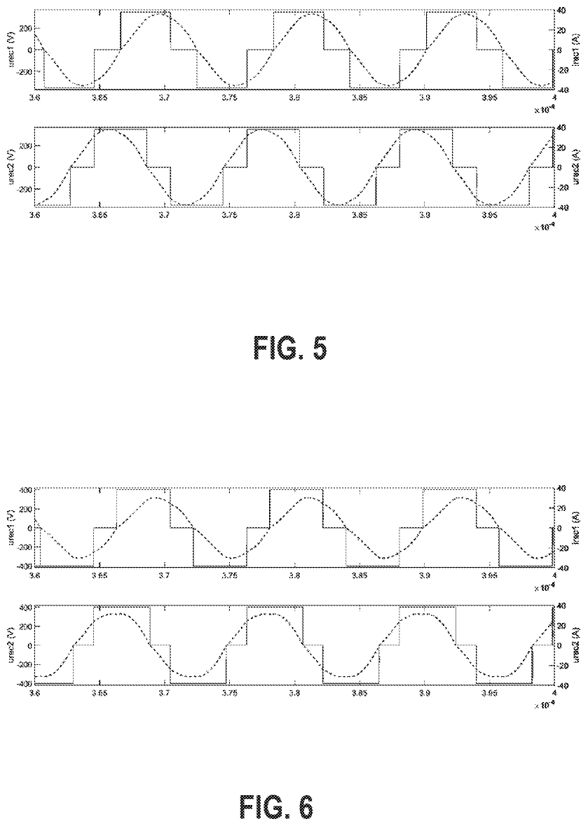

FIG. 5 shows a diagram with a time profile of the component currents irec1 and irec2 and of the two component voltages urec1 and urec2 in the charging device 1 according to the disclosure with the battery voltage Ub of 350V without the commutation circuit 3. In the upper part diagram, the component current irecl is plotted with the dotted line and the component voltage urec1 with the continuous line. In the lower part diagram, the component current irec2 is plotted with the dotted line and the component voltage urec2 with the continuous line.

FIG. 6 shows a diagram with a time profile of the component currents irec1 and irec2 and of the component voltages urec1 and urec2 in the charging device 1 according to the disclosure with the battery voltage Ub of 400V without the commutation circuit 3. In the upper part diagram, the component current irec1 is plotted with the dotted line and the component voltage urec1 with the continuous line. In the lower part diagram, the component current irec2 is plotted with the dotted line and the component voltage urec2 with the continuous line.

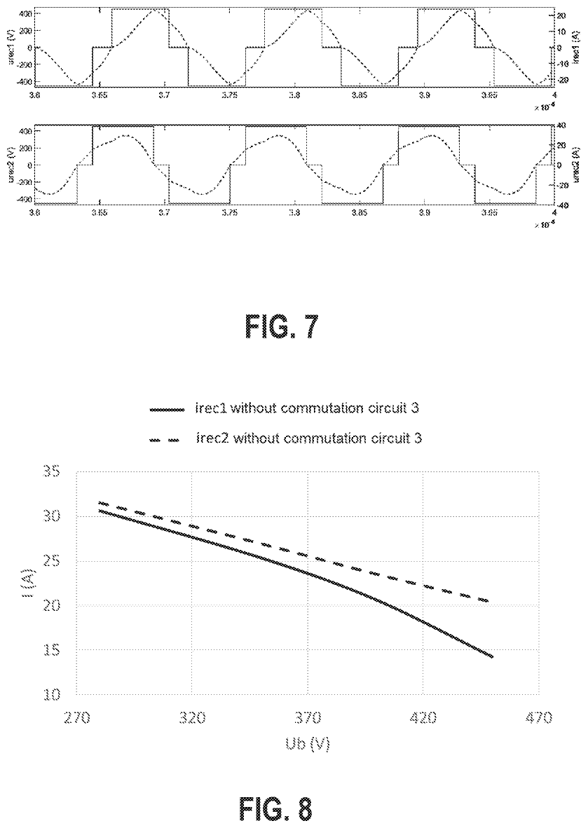

FIG. 7 shows a diagram with a time profile of the component currents irec1 and irec2 and of the two component voltages urecl and urec2 in the charging device 1 according to the disclosure with the battery voltage Ub of 450V without the commutation circuit 3. In the upper part diagram, the component current irecl is plotted with the dotted line and the component voltage urec1 with the continuous line. In the lower part diagram, the component current irec2 is plotted with the dotted line and the component voltage urec2 with the continuous line.

From FIGS. 4 to 7, it is evident that there is a phase angle difference between the component currents irec1 and irec2 and that the phase angle θ decreases with the rising battery voltage Ub. In the charging device 1 according to the disclosure—for example in FIG. 4—there is a timespan in which the component voltages urec1 and urec2 are equal to zero. There is thus a freewheel. The reason for this is that the moment of the commutation for the diode half bridges of the rectifier 4 in the charging device 1 according to the disclosure is different.

FIG. 8 shows a comparative diagram of effective values of the component currents irec1 and irec2 in the charging device 1 from FIG. 1 without the commutation circuit 3 as a function of the battery voltage Ub of the battery Rb. Here, the profile of the first component current irec1 is shown with a continuous line and the profile of the second component current irec2 with the dashed line.

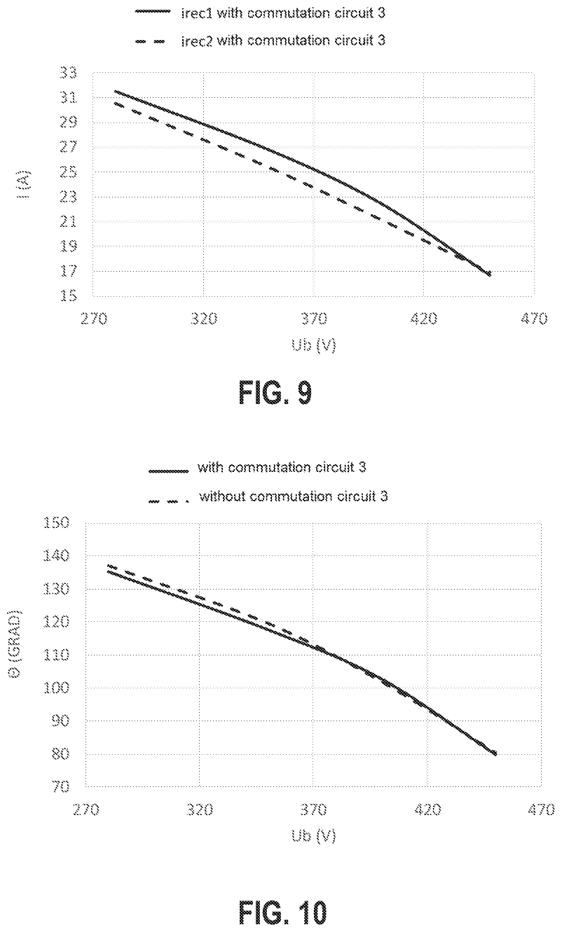

FIG. 9 shows a comparative diagram of effective values of the component currents irec1 and irec2 in the charging device 1 from FIG. 1 with the commutation circuit 3 as a function of the battery voltage Ub of the battery Rb. Here, the profile of the first component current irecl is shown with a continuous line and the profile of the second component current irec2 with a dashed line.

FIG. 10 shows a diagram of a phase angle difference between the component currents irec1 and irec2 in the charging device 1 from FIG. 1 with and without the commutation circuit 3 as a function of the battery voltage Ub of the battery Rb. Here, the phase angle difference with the commutation circuit 3 is shown with a continuous line and the phase angle difference without the commutation circuit 3 with a dashed line.

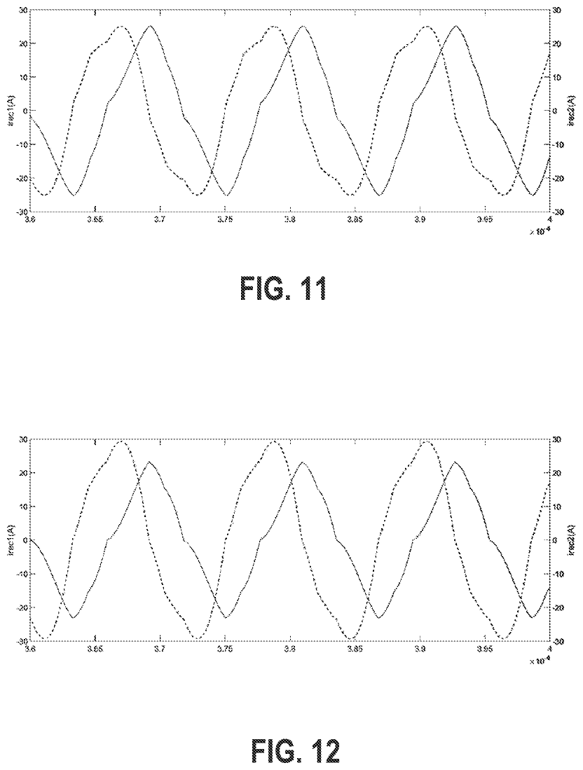

FIG. 11 shows a comparative diagram with a time profile of the two component currents irecl and irec2 in the charging device 1 according to the disclosure with the battery voltage Ub of 450V with the commutation circuit 3. Here, the component current irec1 is plotted with the continuous line and the component current irec2 with the dotted line.

FIG. 12 shows a comparative diagram with a time profile of the two component currents irec1 and irec2 in the charging device 1 according to the disclosure with the battery voltage Ub of 450V without the commutation circuit 3. Here, the component current irec1 is plotted with the continuous line and the component current irec2 with the dotted line.

It is understood that the foregoing description is that of the exemplary embodiments of the disclosure and that various changes and modifications may be made thereto without departing from the spirit and scope of the disclosure as defined in the appended claims.

What is claimed is:

1. A charging device for the wireless reception of energy, the charging device comprising:
a passive auxiliary circuit; and
a rectifier connected downstream of the auxiliary circuit,
wherein the passive auxiliary circuit comprises a first and a second input node and a first, a second, and a third output node,
wherein between the first input node and the first output node a first impedance is connected and between the first input node and the second output node a second impedance is connected, and
wherein an imaginary component of the first impedance has a positive non-zero value and an imaginary component of the second impedance has a negative non-zero value or vice versa.

2. The charging device according to claim 1, wherein the positive or negative value of the imaginary component of the first impedance and the negative or positive value of the imaginary component of the second impedance are equal in the amount.

3. The charging device according to claim 1, wherein:
between the second input node and the third output node of the auxiliary circuit a third impedance is connected, and
an imaginary component of the third impedance has a positive or negative non-zero value or in a resonance case a value equal to zero.

4. The charging device according to claim 1, wherein:
the respective impedance is formed by a coil, or
the respective impedance is formed by a coil and a capacitor which are connected in series.

5. The charging device according to claim 1, wherein:
the charging device comprises a commutation circuit which is connected between the passive auxiliary circuit and the rectifier,
the commutation circuit comprises at least one commutation capacitor, and
the at least one commutation capacitor is connected between two of the respective output nodes of the auxiliary circuit.

6. The charging device according to claim 1, wherein:
the rectifier comprises a first, a second, and a third input node and a first and a second output node, and
the respective input node of the rectifier is connected in each case to the respective output node of the auxiliary circuit.

7. The charging device according to claim 6, wherein:
the rectifier comprises three diode half bridges, and
the respective diode half bridge in each case is connected between one of the respective input nodes of the rectifier and two of the respective output nodes of the rectifier.

8. The charging device according to claim 6, wherein:
the rectifier comprises a compensation capacitor, and
the compensation capacitor is connected between the output nodes of the rectifier.

9. The charging device according to claim 1, wherein:
the charging device comprises a secondary charging coil for the wireless reception of energy and a reactive power compensation network for offsetting reactive power, and
the charging coil is connected upstream of the reactive power compensation network and the reactive power compensation network is connected upstream of the auxiliary circuit.

10. The charging device according to claim 1, wherein:
the charging device comprises a battery for storing energy received, and
the battery is connected downstream of the rectifier.

11. The charging device according to claim 1, wherein the charging device is provided for the inductive charging of motor vehicles.
